(19) United States
(12) Patent Application Publication
(10) Pub. No.: US 2017/0248418 A1
(43) Pub. Date: Aug. 31, 2017

(54) METHOD OF DETECTING FLOW LINE DEPOSITS USING GAMMA RAY DENSITOMETRY

(71) Applicant: SHELL OIL COMPANY, Houston, TX (US)

(72) Inventors: Rajneesh VARMA, Houston, TX (US); Gregory John HATTON, Houston, TX (US)

(21) Appl. No.: 15/519,769

(22) PCT Filed: Oct. 20, 2015
(86) PCT No.: PCT/US2015/056403

§ 371 Date: Apr. 17, 2017

Related U.S. Application Data
(60) Provisional application No. 62/067,203, filed on Oct. 22, 2014.

(51) Int. Cl. G01B 15/02; G01N 17/00; G01N 9/24; G01N 23/08

(52) U.S. Cl. CPC G01B 15/025; G01N 23/08; G01N 17/008; G01N 9/24; G01N 2223/1013; G01N 2223/633; G01N 2223/635

(57) ABSTRACT

A method of measuring a flow line deposit comprising: providing a pipe comprising the flow line deposit; measuring unattenuated photon counts across the pipe; and analyzing the measured unattenuated photon counts to determine the thickness of the flow line deposit and associated systems.

### CROSS REFERENCE TO RELATED APPLICATIONS

This application claims the benefit of U.S. Provisional Application No. 62/067,203, filed Oct. 22, 2014, which is incorporated herein by reference.

### BACKGROUND

The present disclosure relates generally to methods for detecting flow line deposits using gamma ray densitometry. More specifically, in certain embodiments, the present disclosure relates to methods for measuring the thickness of flow line deposits using non-invasive gamma ray densitometry and associated systems.

Deposits of substances from production streams in flow lines are a common occurrence in the oil and gas industry. These deposits, if unattended, build over a period of time and reduce the effective cross sectional area available for the flow, thereby increasing pressure drops or reducing the flow of the hydrocarbons. In extreme cases, the deposits may build to fill the lumen leading to complete blockage of the flow line and thereby impacting the availability of hydrocarbons. The blocked flow lines are particularly hard to remediate and may need to be replaced if not remediated. The remediation may get more complex in subsea environments where accessibility may be limited or interventions may be expensive, and replacement costs may be higher than at onshore location.

Advance, or online knowledge, of deposit formation can help the remediation strategies and prevent complete blockage of flow lines. Current or real time information about the extent of deposits can be used to develop an optimal pigging strategy which effectively clears deposits, while it is cost efficient in terms of application frequency. Since the deposits may form on the inner walls of flow lines which are typically insulated, or in pipe-in-pipe configuration with the annular space filled with insulation material, it's hard to inspect the pipes and quantify deposit formation. Other sensors, such as pressure transducers or temperature probes, are invasive and are often inserted at the ends of the flow lines. It may not be practical to cover every running foot of the flow line with these invasive sensors.

Examples of non-invasive methods to determine the presence as well as the thickness of a deposit within a pipeline are described in U.S. Patent Application Ser. No. 62/027,574, the entirety of which is hereby incorporated by referee. While these methods are effective for determining the presence as well as the thickness of a deposit within a pipeline, in certain embodiments they may not provide a complete picture because they may not focus on the flow model of the fluid in the pipe.

It is desirable to develop a non-invasive method to determine the presence as well as the thickness of the deposit within the pipelines that also utilizes knowledge of the flow model of the fluid within the pipelines.

### SUMMARY

The present disclosure relates generally to methods for detecting flow line deposits using gamma ray densitometry. More specifically, in certain embodiments, the present disclosure relates to methods for measuring the thickness of flow line deposits using non-invasive gamma ray densitometry and associated systems.

In one embodiment, the present disclosure provides a method of measuring a flow line deposit comprising: providing a pipe comprising the flow line deposit; measuring unattenuated photon counts across the pipe; partitioning the measured unattenuated photon counts; and calculating the thickness of the flow line deposit based on the partitioned measured unattenuated photon counts.

In another embodiment, the present disclosure provides a method of measuring a flow line deposit of a pipeline with a multiphase flow comprising: providing a pipe comprising the flow line deposit; measuring unattenuated photon counts across the pipe; and analyzing the measured unattenuated photon counts to determine the thickness of the flow line deposit.

In another embodiments, the present disclosure provides a method of measuring a flow line deposit of a pipe comprising: providing a pipeline comprising the flow line deposit; measuring unattenuated photon counts across the a first portion of the pipeline; measuring unattenuated photon counts across a second portion of the pipeline; and analyzing the measured unattenuated photon counts to determine the thickness of the flow line deposit.

### BRIEF DESCRIPTION OF THE DRAWINGS

A more complete and thorough understanding of the present embodiments and advantages thereof may be acquired by referring to the following description taken in conjunction with the accompanying drawings.

FIG. 1 is an illustration of count distributions for intermittent flow along a gamma-ray beam path.

FIG. 2 is an illustration of an intermittent flow within a pipeline.

The features and advantages of the present disclosure will be readily apparent to those skilled in the art. While numerous changes may be made by those skilled in the art, such changes are within the spirit of the disclosure.

### DETAILED DESCRIPTION

The description that follows includes exemplary apparatuses, methods, techniques, and/or instruction sequences that embody techniques of the inventive subject matter. However, it is understood that the described embodiments may be practiced without these specific details.

The present disclosure relates generally to methods for detecting flow line deposits using gamma ray densitometry. More specifically, in certain embodiments, the present disclosure relates to methods for measuring the thickness of flow line deposits using non-invasive gamma ray densitometry and associated systems.

Some desirable attributes of the methods discussed herein are that they are non-invasive methods that are able to more accurately determine the presence and thickness of the deposit and blockages within the pipelines than previous methods. In certain embodiments, the methods described herein, may be used to non-invasively detect solids and solids that have liquid and gas occluded, which deposit on the inner walls of flow lines that transport hydrocarbons such as gas and oils.

The present invention involves the development of a methodology for gathering gamma ray or xray densitometry data of hydrocarbon flow lines. The methodology may include gathering densitometer data and multiphase flow data and processing that data to determine the presence of solid deposits on the inner pipeline wall and blockages in the core or lumen of the flow line.

In certain embodiments, the methods discussed herein may also utilize multiphase flow knowledge during the analysis of gamma-ray acquired data. In certain embodiments, multiphase flow knowledge may allow the gamma-ray acquired data to be partitioned before its analysis. In certain embodiments, the partitioning of the gamma-ray beam data may be based on instantaneous multiphase flow characteristics. In certain embodiments, the partitioning of the gamma-ray beam data may be based on multi-modal data distributions. There may be several benefits of partitioning data, which are discussed below.

One advantage of portioning the data is that it may allow a more accurate determination of the effective attenuation constant of the material in the gamma-ray beam path. In some instances, data taken along a gamma-ray beam path/chord may pass through a pipe containing multi-phase flow. The instantaneous number of un-attenuated gamma-ray photons (counts per acquisition period, C) that traverse the path/chord may be a function of the instantaneous source photon flux, material in the path/chord, and attenuation of that material. In addition to the instantaneous variation in source flux and quantum mechanical material scattering (attenuation), for many multiphase flow patterns (MFP), the contents of the pipe along the gamma-ray path/chord may vary with time.

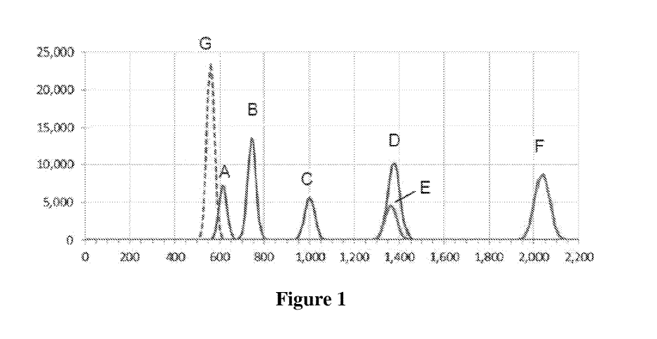

FIG. 1 shows a count distributions (for 10-milli-second acquisition periods) predicted for intermittent flow along gamma-ray beam paths. The distribution for the 1.59 beam path has two primary peaks (Peak A and Peak B). The distribution for the 1.093125 beam path has two primary peaks (Peak C and Peak D). The distribution for the 0.099375 beam path has two primary peaks (Peaks E and Peak F). The distribution for the 3.080625 beam path has a single peak (Peak G). The width of each peak is determined primarily by the source flux and scattering instantaneous variations (proportional to C^{1/2}). The bi-modal character (two peaks) of the distributions and their relative positions are determined by the characteristics of the multiphase flow and specific beam path. Different beam paths have different peak separations and relative heights.

The average of each beam path distribution may be used to determine an “average attenuation” along each beam path. While analysis of the “average attenuation” data for all the beam paths may provide information on some “average attenuation” distribution of attenuation in the target zone, averaging counts before converting to path length in a material introduces an error.

Preferably, the high count-rate peak of each multi-modal distribution may be used with the mono-modal peaks to determine a “high-count-rate attenuation” along each beam path. Analysis of the set of “high-count-rate attenuation” results for all the beam paths provides a different distribution of material inside the pipe from that obtained with analysis of the set of “average attenuation” results. For example, with intermittent flow in the pipe, for gamma-ray beam paths crossing the upper part of a horizontal pipe, “high-count-rate attenuation” data are during time periods in which the Taylor Bubble part of a slug unit is in the beam path.

Similarly, the low count-rate peak of each multi-modal distribution may be used with the mono-modal peaks to determine a “low-count-rate attenuation” along each beam path. Analysis of the set of “low-count-rate attenuation” results for all the beam paths provides a different distribution of material inside the pipe from that obtained with analysis of the set of “average attenuation” results. For example, with intermittent flow in the pipe, for gamma-ray beam paths crossing the upper part of a horizontal pipe, “low-count-rate attenuation” data are during time periods in which the slug unit tail is in the beam path.

Analysis of the “high-count-rate attenuation” attenuation data for all the beam paths, may provide information on the distribution of attenuation in the target zone during those time periods in which the multiphase flow stream distribution within the pipe resulted in the “high-count-rate attenuation”. For example of the attenuation distribution while a slug-unit Taylor Bubble is passing the gamma-ray device. Analysis of the “low-count-rate attenuation” attenuation data for all the beam paths, may provide information on the distribution of attenuation in the target zone during those time periods in which the multiphase flow stream distribution within the pipe resulted in the “low-count-rate attenuation”. For example of the attenuation distribution while a slug-unit tail is passing the gamma-ray device.

Thus it may be preferable to use a strategy to de-convolve the gamma-ray data utilizing (1) the instantaneous counts for all of the beam paths to determine the multiphase flow pattern and the instantaneous element of that flow pattern passing the device at an given instant and (2) the instantaneous element of that flow pattern passing the device at an given instant to interpret the attenuation data of the gamma-ray beam paths.

In one embodiment, the present disclosure provides a method of measuring a flow line deposit comprising: providing a pipe comprising the flow line deposit; measuring unattenuated photon counts across the pipe; partitioning the measured unattenuated photon counts; and calculating the thickness of the flow line deposit based on the partitioned measured unattenuated photon counts.

In certain embodiments, the pipe comprising the flow line deposit may be any pipe described in U.S. Patent Application Ser. No. 62/027,574. In certain embodiments, measuring unattenuated photon counts across the pipe may comprise any of the methods of measuring unattenuated photon counts across the pipe described in U.S. Patent Application Ser. No. 62/027,574.

In certain embodiments, a single-source or multiple-source, multiple-detector gamma-ray device may be used to measure the unattenuated photon counts. In certain embodiments, the data gathered for each source-detector pair or, if the device is non-stationary, for each source-detector-pair-at-each-position beam path for many time periods is gathered for individual time periods that may be shorter than the characteristic times of the flow through the pipeline.

In certain embodiments, the pipe may be a pipe that transports multiphase flow. In certain embodiments, measuring unattenuated photon counts across the pipe may comprise measuring unattenuated photon counts along multiple chords across the pipe.

In certain embodiments, partitioning the measured unattenuated photon counts may comprise partitioning the unattenuated photon counts using slug-unit synchronization. In certain embodiments, partitioning the measured unattenuated photon counts may comprise determining the times of multiphase flow signature along each chord and partitioning the measured unattenuated photon counts along each chord based upon the multiphase flow signature.

In certain embodiments, partitioning the data gathered for each beam path may be portioned into sets based on the instantaneous multiphase flow characteristics within the pipe. The partitioned data may then be analyzed for each set of instantaneous multiphase flow characteristic within the pipe and be de-convolved to provide gamma-ray attenuation information.

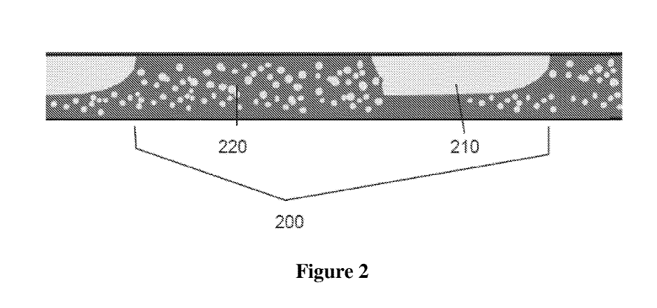

FIG. 2 illustrates a pipeline conveying (or transporting) intermittent flow. As shown in FIG. 2, the intermittent flow may consist of a series of slug units 200. At the front of the slug units 200 there may be a large bubble 210 which is referred to as a Taylor Bubble. The slug or tail 220 is the section of liquid with dispersed bubbles. The Taylor Bubble 210 and the tail 220 together form a slug unit 200.

In certain embodiments, the method may comprise of determining the signature elements of each slug unit in a train of slug units. The signature elements of the jth slug unit in the train may be the beginning of the Taylor Bubble, end of the Taylor Bubble, and the end of the slug unit (beginning of the Taylor Bubble in the next slug unit). The signature can be the spatial positions of these slug unit elements at a given time or the time position at a fixed position along the pipe. For example, in time positions, a signature of slug unit j is the set of 3 times (Tⱼ^{bTB}, Tⱼ^{eTB}, Tⱼ^{eSU}), where:

Tⱼ^{bTB} is the time the beginning of the Taylor Bubble in the jth slug unit passes the fixed position along the pipe;

Tⱼ^{eTB} is the time the end of the Taylor Bubble in the jth slug unit passes the fixed position along the pipe; and

Tⱼ^{eSU} is the time the end of the jth slug unit passes the fixed position along the pipe.

Once all the signatures of all the slug units have been determined, the method may further comprise combining the data in a slug-unit synchronized way. In certain embodiments, combining the data in a slug-unit synchronized way may comprise dividing the slug unit into a number of time segments.

For example, slug unit j Taylor Bubble can be divided up into a number of time segments, k, each with beginning times, tₖ^{TB,j}, where t₀^{TB,j}=tⱼ^{bTB}, and tₙ^{TB,j}=t₀^{TB,j}+t^{TB}ₙ; similarly, the slug unit j tail can be divided up into a number of time segments, tₖ^{tail,j}, where t₀^{tail,j}=Tⱼ^{eTB}, and tₙ^{tail,j}=t₀^{tail,j}+t^{tail}ₙ. The data of all of the slug units at time t^{TB}ₙ after the beginning of each Taylor Bubble may then be combined for each cord l to obtain average values for data in Taylor Bubbles at a time t^{TB}ₙ after the beginning of the Taylor Bubble along cord l. That is, the average counts per gathering period in a Taylor Bubble of the train for a cord l a time t^{TB}ₙ after the beginning of the Taylor Bubble is given by Equation 1:

$$\overline{{C}_{i}^{TB}} ( {t}_{n}^{TB} ) = \frac{1}{\# {SU}_{—} {TB}_{—} {t}_{n}^{TB}} {Σ}_{j = 0}^{\# {SU}_{—} {TB}_{—} {t}_{n}^{TB}} {C}_{i}^{TB , j} ( {t}_{o}^{TB , j} + {t}_{n}^{TB} ) \qquad ( Equation 1 )$$

where the sum is over all Taylor Bubbles in the slug unit train at time t^{TB}ₙ after the beginning of each Taylor Bubble, and #SU_TB_t^{TB}ₙ is the number of such Taylor Bubbles.

Similarly, for each chord 1, the average values for data in slug tails a time t^{tail}ₙ after the beginning of the tail can be determined according to Equation 2:

$$\overline{{C}_{i}^{tail}} ( {t}_{n}^{tail} ) = \frac{1}{\# {SU}_{—} {tail}_{—} {t}_{n}^{tail}} {Σ}_{j = 0}^{\# {SU}_{—} {tail}_{—} {t}_{n}^{tail}} {C}_{i}^{TB , j} ( {t}_{o}^{TB , j} + {t}_{n}^{tail} ) \qquad ( Equation 2 )$$

where the sum is the overall slug units with tails of duration >t^{tail}ₙ, and #SU_tail_t^{tail}ₙ is the number of such slug units.

For a given time, either t^{TB}ₙ or t^{tail}ₙ, the set of average data for each chord may be determined according to Equations 3 or 4:

{CS^{TB}}(tₙ^{TB})=(C̅ₗ̅^̅{̅T̅B̅}̅(̅t̅ₙ̅^̅{̅T̅B̅}̅)̅, for l=1to number of chords) (Equation 3)

{CS^{tail}}(tₙ^{tail})=(C̅ₗ̅^̅{̅T̅B̅}̅(̅t̅ₙ̅^̅{̅t̅a̅i̅l̅}̅)̅, for l=1to number of chords) (Equation 4).

With the attenuation data across numerous chords, techniques may be used to obtain a density distribution within the pipe for that time in a slug unit, R^{TB}(t^{TB}ₙ) Such analyses provide results different from those of traditional analyses, which are averaged over all time. In particular, with the method proposed here, rather than averaging over all fluid distributions of a slug unit, results are obtained for fluid distributions along the slug unit—for example at times t^{TB}ₒ, t^{TB}₁, t^{TB}₂, . . . , t^{TB}_{#SU}_{_}_{TB}_{_}_{tTB}. Results, R, for times in the middle of the Taylor Bubble, R^{TB}_{mid}, and for times in the middle of the tail, R^{tail}_{mid} may have significantly different density distributions. In these results, R^{TB}_{mid} and R^{tail}_{mid}, deposits on the pipe wall exposed in the Taylor Bubble section of the flow will be clearly defined when R^{TB}_{mid} and R^{tail}_{mid} are compared.

This data may then be analyzed according to any of the methods described in U.S. Patent Application Ser. No. 62/027,574 to determine the thickness of the deposit within the pipeline.

In other embodiments, characteristic elements of a multiphase flow pattern may be time tagged and data counts along each chord may be partitioned based on time position between characteristic elements. That data may then be analyzed according to any of the methods described in U.S. patent Application Ser. No. 62/027,574 to determine the thickness of the deposit within the pipeline.

In another embodiment, the present disclosure provides a method of measuring a flow line deposit comprising: providing a pipe comprising the flow line deposit; measuring unattenuated photon counts across the pipe; determining the height variation of a Taylor Bubble within the pipe, and calculating the thickness of the flow line deposit based on the height variation of the Taylor Bubble.

In certain embodiments, the height variation of the front of the Taylor Bubble with time is a function of the flow stream mixture velocity. By analyzing the unattenuated photon counts across the pipe, the height variation of a Taylor Bubble within the pipe can be determined. As the height variation of the Taylor Bubble is a function of the flow stream mixture velocity, the flow stream mixture velocity may be determined based on flow models. Furthermore, as the flow stream mixture velocity is a function of the effective flow cross sectional area of the pipeline (the cross sectional area of the pipe minus the cross sectional area of any deposit) the cross sectional area of any deposit in the pipeline may be calculated.

In another embodiment, the present disclosure provides a method of measuring a flow line deposit of a pipeline with a multiphase flow comprising: providing a pipe comprising the flow line deposit; measuring unattenuated photon counts across the pipe; and analyzing the measured unattenuated photon counts to determine the thickness of the flow line deposit.

In certain embodiments, analyzing the measured unattenuated photon counts to determine the thickness of the flow line deposit may comprise generating a plot of the measured unattenuated photon counts. In certain embodiments, for example when the pipe comprises a multi-phase flow and some of the chords traverse a Taylor Bubble during some data gathering periods and traverse a slug unit tail during other data gathering periods, the generated plot may comprise two separate peaks. Such a plot is illustrated in FIG. 1.

As can be seen in FIG. 1, the distribution of counts for the chord are different during the time the chord traverses the Taylor Bubble and during the times the chord traverses the slug unit tail. For chords with such variation in attenuation with time if the characteristic time of variation is large compared to the counting period the count distribution is multi-modal with distinct peaks, as illustrated in FIG. 1. The difference in counts of the two distribution peaks is the path length in the Taylor Bubble times the difference in attenuation of the tail and Taylor Bubble streams. Comparison of this path length to the chord length within the pipe can be used to determine deposit thickness. Thus, by analyzing the measured attenuated photon counts the thickness of the flow line deposit may be determined.

In another embodiment, the present disclosure provides a method of measuring a flow line deposit of a pipe comprising: providing a pipeline comprising the flow line deposit; measuring unattenuated photon counts across the a first portion of the pipeline; measuring unattenuated photon counts across a second portion of the pipeline; and analyzing the measured unattenuated photon counts to determine the thickness of the flow line deposit.

In certain embodiment, analyzing the measured unattenuated photon counts may comprise correlating the measured unattenuated photon counts across the first portion of the pipeline with the measured unattenuated photon counts across the second portion of the pipeline. In pipelines that experience intermittent flow, the correlation time for Taylor Bubbles within the pipeline may then be obtained. This correlation time for the Taylor Bubbles may then be converted to a Taylor Bubble velocity by dividing the distance between the first portion of the pipeline and the second portion of the pipeline. A multiphase flow model may then be used to convert this time into a mixture velocity. This velocity is divided by the known mixture velocity and multiplied by the known pipe inner cross sectional area to obtain the cross sectional area of the flow. Once the cross sectional area of the flow is determined, the thickness of the deposit may then be calculated.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method of measuring a flow line deposit comprising:
providing a pipe comprising the flow line deposit;
measuring unattenuated photon counts across the pipe;
partitioning the measured unattenuated photon counts; and
calculating the thickness of the flow line deposit based on the partitioned measured unattenuated photon counts.

2. The method of claim 1, wherein measuring unattenuated photon counts across the pipe comprises using a single-source or multiple-source gamma ray device to measure the unattenuated photon counts.

3. The method of claim 1, wherein partitioning the measured unattenuated photon counts comprises partitioning the unattenuated photon counts using slug-unit synchronization.

4. The method of claim 1, wherein partitioning the measured unattenuated photon counts comprises partitioning the unattenuated photon counts based on instantaneous multiphase flow characteristics within the pipe.

5. The method of claim 1, further comprising determining signature elements of a slug unit within the pipe.

6. The method of claim 1, further comprising time tagging characteristic elements of a multiphase flow pattern within the pipe.

7. The method of claim 6, further comprising further comprising partitioning the measured unattenuated photon counts based on time positions between the characteristic elements.

8. A method of measuring a flow line deposit of a pipeline with a multiphase flow comprising:
providing a pipe comprising the flow line deposit;
measuring unattenuated photon counts across the pipe; and
analyzing the measured unattenuated photon counts to determine the thickness of the flow line deposit.

9. The method of claim 8, wherein analyzing the measured unattenuated photon counts to determine the thickness of the flow line deposit comprises determining the height variation of a Taylor Bubble within the pipe.

10. The method of claim 9, wherein analyzing the measured unattenuated photon counts to determine the thickness of the flow line deposit comprises calculating the thickness of the flow line deposit based on the height variation of the Taylor Bubble.

11. The method of claim 8, wherein analyzing the measured unattenuated photon counts to determine the thickness of the flow line deposit comprises generating a plot of the measured unattenuated photon counts.

12. The method of claim 11, further comprising analyzing the plot of the measured unattenuated photon counts to determine the thickness of the flow line deposit.

13. A method of measuring a flow line deposit of a pipe comprising:
providing a pipeline comprising the flow line deposit;
measuring unattenuated photon counts across the a first portion of the pipeline;
measuring unattenuated photon counts across a second portion of the pipeline; and
analyzing the measured unattenuated photon counts to determine the thickness of the flow line deposit.

14. The method of claim 13, wherein analyzing the measured unattenuated photon counts to determine the thickness of the flow line deposit comprises correlating the measured unattenuated photon counts across the first portion of the pipeline with the measure unattenuated photon counts across the second portion of the pipeline.

15. The method of claim 14, further comprising obtaining the correlation time for the Taylor Bubble within the pipeline.

16. The method of claim 15, further comprising converting the correlation time for the Taylor Bubble within the pipeline to a Taylor Bubble velocity.

17. The method of claim 16, further comprising converting the Taylor Bubble velocity into a mixture velocity.

18. The method of claim 17, further comprising determining the thickness of the flow line deposit based upon the mixture velocity and a known inner cross sectional area of the pipeline.
